(19) United States
(12) Patent Application Publication
(10) Pub. No.: US 2004/0122894 A1
(43) Pub. Date: Jun. 24, 2004

(54) Electronic data exchange system for users acting as both servers and receivers of information

(76) Inventor: Heinz Hermann Wippersteg, Buende (DE)

Correspondence Address: STRIKER, STRIKER & STENBY, 103 East Neck Road, Huntington, NY, 11743, US

(21) Appl. No.: 10/668,474

(22) Filed: Sep. 23, 2003

(30) Foreign Application Priority Data
Sep. 26, 2002 (DE) 102 45 169.9

(51) Int. Cl. G06F 15/16

(52) U.S. Cl. 709/203

(57) ABSTRACT

In the electronic data exchange system for communication between multiple users (6), the users (6) operate as both receivers (4) of information (9-11) and servers (5) of information. At least one user (6) of a data transmission network (2) generates required information (9), operating as a server (5), according to specific standards. This required information (9) is retrieved and/or edited by the respective receivers (4). This provides a data exchange system (1), which is suitable to optimize required process chain and management chain. A method of electronic data exchange between multiple users of an electronic data exchange network, in which each user can be both receiver and server of information, is described.

### BACKGROUND OF THE INVENTION

1. Field of the Invention

The present invention relates to a system for electronic data exchange between plural users by means of at least one data exchange system, in which the each user can both be a server and also receiver of information by electronic data exchange. It also relates to a method of electronic data exchange between such users using the at least one data exchange system.

2. Description of the Related Art

The efficiency of the production processes and marketing success of production are increasingly determined by how rapidly the latest scientific knowledge is applied, new technologies are transferred and interdisciplinary information is made available. Global data exchange and information systems have attained increasing significance in this connection. Besides the view point of lowering costs in the production process the invention concerns, above all, customer information systems, which put the users of machines or machine systems, in a position to increase, among other things, their productivity by efficient methods of machine operation. Also it is in the interest of the operator of the machines to keep the repair-dependent idle time small. It is especially important in this connection to provide for early detection of worn parts, the rapid and economical provision of replacement parts and the exchange of defective component groups in time intervals in which the machines are idle. When machines are connected together in a complex process chain, their efficient use depends largely on the optimization of the entire process chain. Because of the complexity of this process chain a significant efficient optimization of the process chain is only possible with the assistance of an electronic data exchange and information system.

In the field of production, further processing and marketing of agricultural products the problem still occurs, that the products themselves and the processing and management chain concerning these products are affected by complex natural controlling influences both in the so-called primary production process and also during further processing. For these reasons optimization processes are essentially limited to mobile and stationary machine systems so that only optimization of small parts of the machine system is possible within a complex process chain. In addition existing extensive geographic information systems make available information, for example regarding the geographic conditions and weather, in certain application areas for mobile machines to the operators of the machine systems according to the needs of the operators. Also these geographic information systems are limited to optimization of a small section of the complex process chain, production, further processing and marketing of agricultural products. The essential disadvantage of this known optimization system is that, above all, a continuous or uninterrupted communication process is not possible. The data produced in partly very different data exchange and information systems are not interchangeable with each other. Up to now they cannot be put together or assembled in a common data packet with a content that meets the information requirements of the individual user.

The most different data exchange and information systems are known in the prior art, whose goals are to optimize the process chain. For example, reference should be made at this point to WO 01/75657, which discloses a method for a manufacturer of products, which is based on electronic business procedures, which optimizes the purchase of parts for the manufacturer's production process. Analogous to other known systems of this type, an exchange of data occurs only between a particular manufacturer, here the client, and the supplier. These types of systems are only oriented to the generation of supply distribution and optimization of the delivery transactions of certain particular products for production by certain particular manufacturers. However these prior art systems cannot perform overlapping control and optimization of the management processes, which comprise the many steps in the process chain. Also this type of system is not in a position to generate information for certain clients based on their information needs from third party information. They cannot then make this information equally available for other users with similar or the same information requirements, who use it and who can act on the basis of the information content, can change or add to it.

### SUMMARY OF THE INVENTION

It is an object of the present invention to develop a system based on electronic data exchange, which comprises information generated according to the needs or requirements of the users, which can be used and edited by the users of the data exchange system serving them.

It is also an object of the present invention to provide a method of electronic data exchange, in which users requesting information can operate as both receivers of information and servers of information, so that data exchanged between users can be used and edited by the users.

This object, and others which will be made more apparent hereinafter, is attained in a system based on electronic data exchange for communication between a plurality of users, in which the respective users can operate both as servers and receivers of information by electronic data exchange.

According to the invention a user, or a group of users, of at least one data transmission network operating as a server or servers generate required or needed information, wherein the needed or required information is generated according to specific standards, and this needed or required information generated according to the specific standards is retrieved or received and/or edited by at least one other user of the at least one data transmission network. operating as at least one receiver of the information, based on need of the individual users.

When one or more users of the at least one data exchange system acting as a server or servers generate the required or needed information according to specific standards, which can be ascertained and/or edited by the users of the at least one data exchange system based on need of a particular receiver, a data exchange system is provided, which is suitable to optimize the branch-overlapping process and management chains.

An especially efficient structure for a data exchange system is then achieved when the provider of the required information makes it available as part of or in the form of a service to the receiver. This has the special advantage that an open branch-overlapping communication is provided, which is independent of data format, since the generating of information within a service is independent of the data exchange system of the user.

In an additional preferred embodiment of the invention it is advantageous when standardization of data exchange takes place on the level of communication between the server and the receiver, so that required compilation processes are unnecessary.

Since the service provider makes the needed information available in a timely manner, time-consuming reading or reviewing of all available information by the receiver is eliminated. Furthermore the particular information that is immediately needed for optimization of certain processes is present prior to the beginning of these processes. Thus delays and associated increased costs because of the tedious information review and search are eliminated.

An especially efficient supply of information is thus achieved when the user can generate question postings, which then are answered by one or more servers of the services, without the need for the user to contact the server directly. This has the special advantage that the user is relieved from time-consuming searching process for selection of a suitable service that provides the needed information. This sort of data exchange also places a significant role when machines want to exchange data with each other.

Another advantageous embodiment of the data exchange system according to the invention is then obtained when the service provider contacted by the user draws in another server of another service for generating the required information for the user operating as receiver. This has the advantage for the receiver of the required information that the quality of the required information is considerably improved, since the process or management chain optimization usually requires special interdisciplinary knowledge, which generally cannot be obtained from specialized service providers.

The service provided can be made available permanently or according to need to the receiver depending on the character of the process or management chain to be optimized in the receiver. Especially during optimization of the processes that frequently change because of external influences, such as in the process of harvesting fruit fields, permanent availability of the service provider can be important. However a permanent availability of the service provider is not required in regard to inside production processes with few large variations in regarding to the reliability of the equipment.

An additional improvement quality of the required or needed information can be achieved when the information prepared by the service provider extends beyond the individual question postings posted by the user, so that the receiver obtains background information for the process or management chain to be optimized. References to other service providers in the provided information can be especially significant here.

So that the needed or required information for the receiver can be made available to the receiver in a useful easily viewed manner, in a preferred embodiment of the invention it can be made available to the receiver by a single provider or several providers according to the kind or type of information. It is appropriate to reduce the number of service providers transmitting the information to the receiver and to limit as much as possible the service provider to a single service provider with increasing complexity of the information.

A great flexibility and universal applicability of the data exchange system according to the invention is achieved, when both the service provider and also the receiver of the required information can be a stationary or mobile unit. This is especially important since the process and/or management chain usually also includes vehicles or mobile workstations.

Another advantageous embodiment of the system according to the invention based on electronic data exchange is attained when both the provider of the service and the receiver of the required information can alternately exchange information. Thus the optimized parameters of the process or management chain may possibly be rapidly made available immediately to further active users under similar prerequisites. This can be accomplished without the determination of the same optimization parameters by the additional active users, which were first determined by the service provider.

Known global and local data exchange systems, such as the Internet or a radio network, can be used to hold down costs for operation of the data exchange system according to the invention in a preferred embodiment of the invention.

Especially in systems with mobile or stationary units, which the operator can observe only with difficulty, it can be important to provide these units with sensors. The sensors generate specific information in certain units, which then can be made available to additional users over the data exchange system according to the invention.

### BRIEF DESCRIPTION OF THE SEVERAL VIEWS OF THE DRAWING

The objects, features and advantages of the invention will now be illustrated in more detail with the aid of the following description of the preferred embodiments, with reference to the accompanying figures in which:

FIG. 1 is a schematic block diagram of a system according to the invention based on electronic data exchange;

FIG. 2 is an additional schematic block diagram of another system according to the invention based on electronic data exchange; and

FIG. 3 is a schematic block diagram of a particularly preferred concrete embodiment of the system according to the invention based on electronic data exchange.

### DETAILED DESCRIPTION OF THE INVENTION

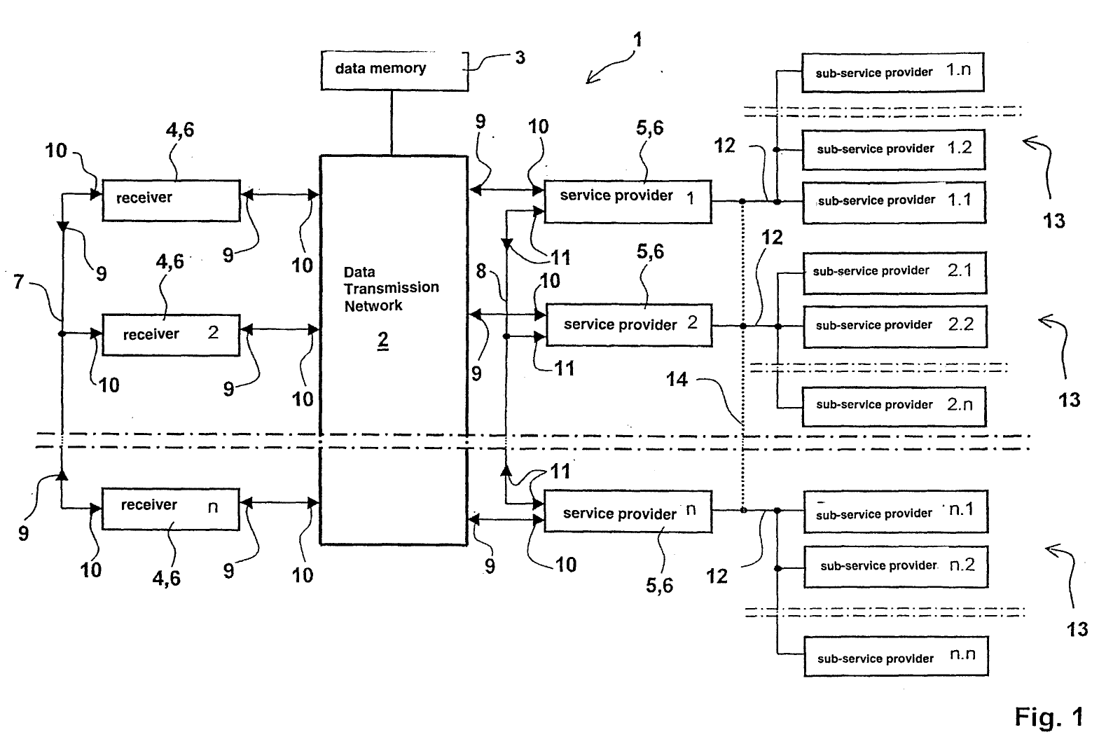

FIG. 1 shows a schematic block diagram of the data exchange system 1 according to the invention. A data transmission network 2 forming the basis for the data exchange system according to the invention is associated with at least one central data memory 3. The data transmission in the data transmission network 2 can occur in a wireless manner and also over known electrically wired networks. The data transmission network 2 comprises one or more receivers 4 and one or more service providers 5, which are connected with each other in the data transmission network 2. They can be connected with each other with wireless and/or electrically wired connections. The receivers 4 and the service providers 5 form the users 6 of the data exchange system 1 according to the invention. Also both the receivers 4 and the service providers 5 can be connected in known wired or wireless transmission networks 7,8 for the purpose of data exchange. The users 6 operating as receivers 4 of the data exchange system 1 relate or refer to the required or needed information 9 of the service provider 5 in a manner to be described in more detail hereinbelow. Also the receivers 4 themselves can generate needed information 10, which is retrieved up by means of the respective data transmission networks 2,7 from the service providers 5 and also from the additional receivers 4. Also the users 6 operating as service providers 5 of the data exchange system 1 according to the invention can exchange needed information 11 over the data transmission network 8 which connects them with each other. For generation of the required information 9 the service providers 5 can be connected with sub-service providers 13 in addition to exchanging information with each other by means of the data exchange network 12. These sub-service providers 13 cannot directly communicate with the receivers 4 of the required or needed information 9 to be generated. This has the advantage that the service provider 5 can refer to a number of different information sources 13 according to its own judgement to improve the quality of the generated information demanded from it. This can take place without optimization of the required or needed information 9 sent to them by the receivers 5 by reference to additional service providers. In contrast it is possible that different service providers 5 can access the sub-service providers 13 of other service providers 5 in order to supply the information. Within the scope of the present invention a single data transmission network 2 can take the place of the data transmission networks 2, 7, 8, 12 and 14 in the embodiment shown in FIG. 1. So that the information 9 to 11 exchanged between the receivers 4 and the service providers 5, 13 in the data transmission networks 2, 7, 8, 12, 14 can be retrieved by the individual users 6 in a simple manner, this information 9 to 11, and the generating programs underlying it, are preferably written in XML standard. An especially efficient data exchange is achieved when the data exchange system according to the invention is converted into so-called Internet Standard, since the Internet is widely used as global data exchange system. Its structures, such as IP addresses and UDDI standards are familiar and widely used.

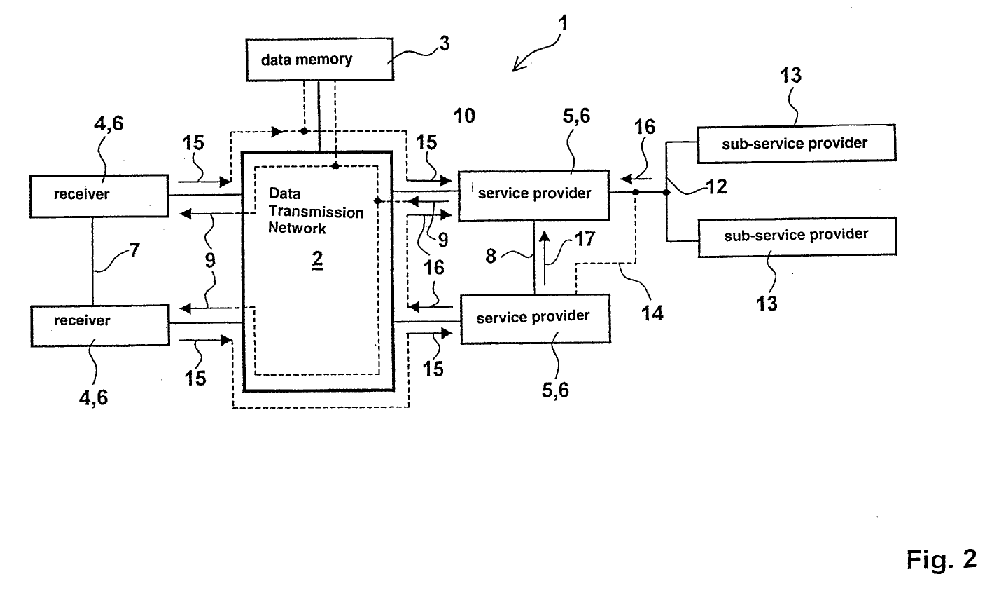

The principle of data exchange in the data exchange system 1 according to the invention is illustrated in FIG. 2 and is described in more detail in the following. In order to make it easier to understand this principle the system illustrated in FIG. 2 has only two receivers 4, two service providers 5 and similarly two sub-service providers 13. Within the scope of the invention the data exchange system 1 according to the invention can be formed by an arbitrary number of receivers 4, service providers 5 and sub-service providers 13. At least one user 6 operating as receiver 4 generates a user-specific question posting 15, which is received and processed by at least one service provider 5. The supplying of the information 16, 17 includes the reworking or processing of the user-specific question posting 15. In a first embodiment the supplying of the information 16,17 is designed so that the service provider 5 directly calls up information 16,17 for answering the user-specific question posting 15 from additional service providers 5 and/or sub-service providers 13. Then it analyzes and structures it and transmits the required information 9 directly to the receiver 4. In an additional embodiment the required information 9 can also be generated in such a way that a first service provider and, if necessary, an associated sub-service provider 13 generates receiver-specific required information 16, which is then completed by one or more additional service providers 5 and, if necessary, associated sub-service providers 13. Then it makes the completed information available to the receiver 4. Since both process chain and management chain are considerably influenced by each other by rapidly changing parameters, it must be possible to edit the required or needed information 9 generated by the service providers 5 and the information 10 generated by the receivers. For this purpose the data memory 3 for the data exchange system 1 according to the invention should be addressable. When the data memory 3 is addressable the receiver 4 can store its question posting 15 and information 10 and also the service provider 5 can store the generated required information 9 in the data memory 3. Also the stored information 9 can be retrieved and edited by arbitrary users 6 of the data exchange system 1. In a known manner access to the data 9, 10, 15 stored in the memory 3 can be structured hierarchically, so that only certain users 6 can access certain data 9, 10, 15 and the reverse. Also only certain users are authorized to edit the data 9, 10, 15 stored in the data memory 3. This so-called online-updating of the information 9, 10, 15 stored in the data memory 3 has the advantage that the receivers 4 can rapidly retrieve updated required information 9 in response to a single generated question posting 15 before the information retrieval time delayed by optimization expires. According to the type of the process or management chain the receiver 4 of the required information can be connected permanently or temporarily with the data exchange system 1 according to the invention. This is of considerable importance considering the usage fee of the service providers 5 for making the required information 9 available and the usage fee of the network operator. The required information 9 to be transmitted to the receiver 4 generated in a user-friendly format, which is usable by the receiver 4 without expensive review processes, can be provided in an advantageous additional embodiment. This additional embodiment accomplishes this by generating the required information 9 in a single service provider 5 and storing it in the data memory 3 for the receiver 4 so that it is retrievable and editable. As already described the supplying of the information of a service provider 5 can also occur making reference to additional service providers 5 or sub-service providers 13.

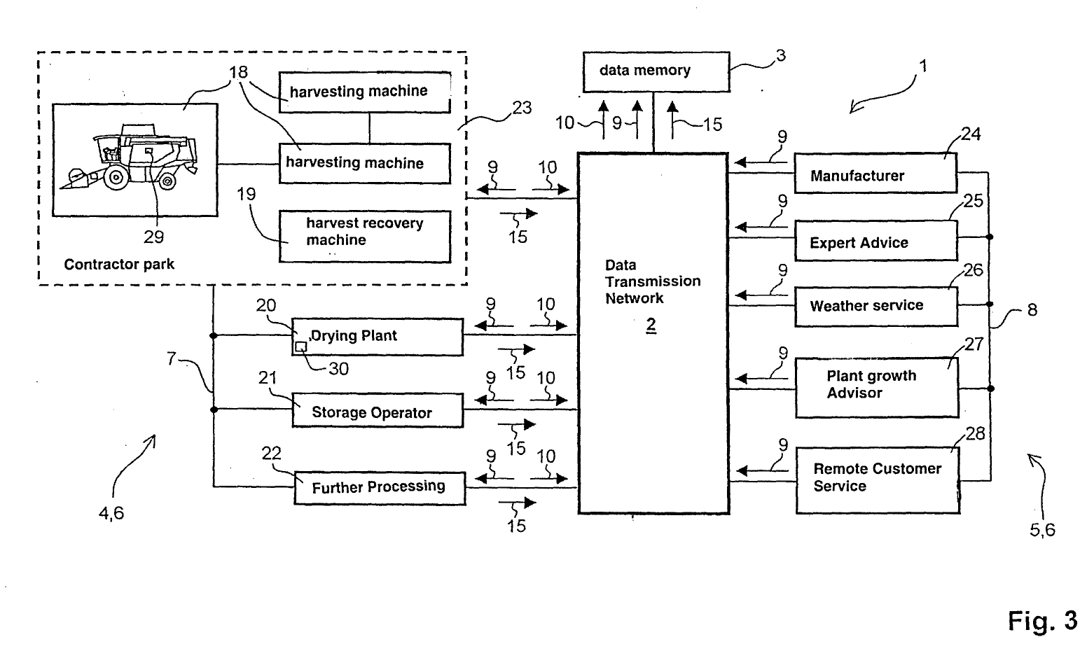

An agricultural process chain and management chain is shown in FIG. 3 as a concrete example of the basis system for electronic data exchange. The data exchange system 1 includes a data exchange network 2 with integrated data memory 3. The users 6 operating as receivers 4 of the required information 9 here are one or more arbitrarily structured harvesting machines 18, harvest recovery machines 19, drying plants 20 associated with them, storage operations 21 and arbitrarily further processing 22 to form agricultural products. The dashed box in FIG. 3 contains harvesting machines 18 with crop sensors 29 and a harvest recovery machine 19 operating as users 6 of the data exchange system 1 according to the invention. The dashed box collectively indicates the park 23 of one or more paid contractor, which operates as a user 6. In order to simplify the following it will be assumed that only the paid contractor 23 is connected with the data transmission network 2 of the data exchange system 1 according to the invention. However within the scope of the invention each individual harvesting machine and each individual harvest recovery machine 19 can be connected with the data transmission network 2. Similarly the data transmission network 2 is connected with a drying plant 20, a storage operator 21 and an arbitrary further processor 22 of agricultural products. Also the users 18 to 22 can be connected with each other in a wireless or wired fashion. In the illustrated embodiment the users 6 operating as service providers 5 include one or more manufacturers 24 of the harvesting machines 18 and/or harvest recovery machines 19 participating in the process, service providers of expert advice 25, of weather information 26, of planting advisories 27 and providers of remote customer services 28. This explicit enumeration is only exemplary and not limited to these. Very different service providers come into consideration as service providers 5, in as much as the services offered are only suitable to prepare the required information 9 according to the question postings 15 generated by the receivers 4. The exemplary enumerated service providers 24 to 28 are similarly connected with the data transmission networks 2,8 of the data exchange system 1 according to the invention. No sub-service providers 13 are shown in FIG. 3, also to make understanding this figure easier. However within the scope of the invention the illustrated service providers 24 to 28 could be provided in the already described manner with the so-called sub-service providers 13. Each of the users 6 operating as receiver can now generate question postings 15 in the data exchange system according to the invention, which are first stored in the data memory 3 and then processed by one or more of the users 6 operating as service providers 5. Also the receivers 4 can themselves generate information 10, which is stored in the data memory 3 by means of the data transmission network 2. The service providers 24 to 28 retrieve the question positions 15 and the information 10 stored in the data memory 3. The service providers 24 to 28 do their part and generate the required or needed information 9 for the receivers 4 according to the invention and it is stored in the data memory 3. Finally the receiver 4 can retrieve the required or needed information 9 from the data memory 3 permanently or sporadically according to need. It is possible in this way to perform a branch-overlapping optimization of the process and management chains, harvesting, recovery, storage, further processing and marketing of agricultural products, in which the users 6 of the data exchange system 1 can exchange and edit information 9, 10, 15 with each other. An essential advantage of this sort of system is that the data 9, 10, 15 stored in the memory 3 is permanently updated and can be further developed in the sense of a self-improving system, so that its information content has a qualitatively increasing high value. This especially has the advantage for the receivers 4 of the required information 9 that the optimization of its process and management chain is continuously improved.

The question postings 15 generated by the receivers 4 of the required information 9 can be very different. An efficient park management, above all, besides the question of optimum adjustment of the respective working mechanisms of the machines 18, 19, plays an essential role in the area of operation of the harvesting machines 18 and harvest recovery machines 19. The operator of the harvesting machines 18, 19 is greatly interested in remote diagnostic monitoring methods for his machines by the respective manufacturers. In this way, for example, wear and tear of parts can be detected and replacement of these worn parts can be organized so that repair-dependent out-of-service time is kept to a minimum or entirely avoided. Especially in the area of park management of paid contractors 23 it is important for the coordinated usage of the machines to be informed regarding aging and the harvesting time point connected with that. Also weather prediction always plays an important role also in the planing of the use of the harvesting machines 18, 19, since the harvest conditions are strongly weather dependent. In this connection especially information from weather services 26 and remote customer services 28, which especially determine their maturity with the help of plant structure, as well as information regarding plant structure advisors 27, are especially important.

Furthermore the quality of the harvested products and the amount of the harvested goods to be expected are known to be important for the operators of drying plants 20 and storage operations 21. Especially this sort of information is of particular importance for planing of storage and drying capacity. Here another aspect of the invention arises. Since the harvesting machines 18, 19 themselves have known sensors 29, which measure the amount of harvested material and its moisture, additional needed or required information 10 is generated by the harvesting machines 18,19 themselves. This additional needed information 10 is transmitted over the data transmission network 2 of the data exchange system 1 according to the invention to the remaining users 6 and thus especially for the operation of the drying plant 20 and storage operation 22. Also it is conceivable that the drying plant 20 or the harvested goods storage unit 21 are equipped with unshown sensors 30, which are known in themselves, which generate the respective filling degrees and their momentary filling degree. Thus the receivers 4 of the required information 9 are usable at the same time as suppliers of required information 10, which is useable by the remaining users 6 of the data exchange system 1 according to the invention.

This alternate exchange of information 10 has special significance, since the harvesting machines 18,19 integrated into the data exchange system 1 can exchange optimized adjustment parameters with each other, so that a time-consuming generation of the question postings 15 for a part of the harvesting machine 18,19 can be eliminated. Also possibilities of this sort lead to optimization within the process and management chain in the agricultural production.

Finally also further processing operations 22 profit from the data exchange system 1 according to the invention, since they already at an earlier time obtain information regarding the conditions or properties of the products to be processed. This is especially significant in these processing operations, which extract certain ingredients of the product from it, such as the obtaining of sugar from sugar cane or tube.

A branch communication is possible with the disclosed system 1 based on electronic data exchange, which is oriented to the requirements of respective users 6 generating question postings 15. The users 6 operating as receivers 4 of the required information 9 also can be so-called virtual participants. Especially these virtual participants can be quality producing chains in the field of agricultural production, which collect quality data from growth to marketing and made it available as required information to the users 6.

The system 1 based on electronic data exchange according to the invention is not limited to the described embodiments, but can be generally applied to interdisciplinary situations, in which the process and management chain is to be optimized.

The disclosure in German Patent Application 102 45 169.9 filed Sep. 26, 2002 in Germany is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in an improved electronic data exchange system, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

I claim:

1. A system based on electronic data exchange, in which the data exchange occurs between a plurality of users by means of at least one data exchange system and each of said users is operable as both a server and a receiver of information, wherein at least one user of at least one data transmission network generates required information according to specific standards, said at least one user functioning as said server, and at least one other user of said at least one data transmission network retrieves the required information and/or edits the required information generated by the at least one user, adjusted according to needs of the at least one other user, said at least one other user functioning as said receiver.

2. The system as defined in claim 1, wherein said server makes said required information, adjusted to said needs of said at least one other user, available to. said at least one other user in the form of a service.

3. The system as defined in claim 1, wherein server groups identify themselves as services that are accessible to said at least one user.

4. The system as defined in claim 2, wherein said server defines access rights to said service.

5. The system as defined in claim 2, wherein said server makes said required information available in timely manner as part of said service and makes said required information, adjusted to said needs of said at least one other user operating as said receiver, available to said at least one other user.

6. The system as defined in claim 2, wherein said receiver generates question postings, which are transmitted by means of said at least one data transmission network to said server providing said service and wherein said service of said server comprises answering said question postings.

7. The system as defined in claim 6, wherein said service of said server comprises referring to at least one other service of at least one other server and/or to sub-service providers.

8. The system as defined in claim 6, wherein said service of said server is permanently or temporarily connected as need requires to said receiver generating said question postings.

9. The system as defined in claim 6, wherein said service of said server provides additional information that is not expressly required by said receiver, which increases service quality provided by said server.

10. The system as defined in claim 9, wherein said server providing said service obtains said additional information by retrieving said additional information from another service provided by another service provider.

11. The system as defined in claim 1, wherein services of a plurality of service providers are made available to said receiver by said server and/or a selection of said services is made available to said receiver by a number of different service providers.

12. The system as defined in claim 2, wherein said server providing said service is a stationary unit or a mobile unit and wherein said stationary unit or said mobile unit communicates via said at least one data exchange system with said receiver and/or said server.

13. The system as defined in claim 1, wherein said server and said receiver alternately exchange said required information by means of said at least one data exchange system.

14. The system as defined in claim 13, wherein said at least one data exchange system is global or spatially limited.

15. The system as defined in claim 12, wherein said stationary unit or said mobile unit have sensors for generating receiver-specific information, and said receiver-specific information is made available to at least one service provider and/or at least one further receiver by means of said at least one data exchange system.

16. The system as defined in claim 1, wherein said information generated by said users in said data transmission network is generated in a standardized format.

17. The system as defined in claim 1, wherein said users comprise machines and/or businesses engaged in planting, caring for, harvesting, storing and/or processing of agricultural products; machine manufacturers; weather services; crop advisory services and planting advisors and wherein said required information includes data for optimizing a processing chain and/or a management chain for producing said agricultural products.

18. A method of communication between a plurality of users of at least one data exchange system in which each of said users operates as both a server and a receiver of information, said method comprising the steps of:
a) producing required information in at least one user of at least one data transmission network according to specific standards, said at least one user functioning as said server; and
b) picking up said required information by at least one other user of said at least one data transmission network and/or editing the required information generated by said at least one user, adjusted according to needs of said at least one other user, said at least one other user functioning as said receiver.

19. The method as defined in claim 18, further comprising making said required information, adjusted according to said needs of said at least one other user, available to said at least one other user in the form of a service of said server.

20. The method as defined in claim 19, wherein said server defines access rights to said service.

21. The method as defined in claim 19, wherein said server makes said required information available in timely manner as part of said service and makes said required information matched to said requirements of said at least one other user available to said at least one other user in a timely manner.

22. The method as defined in claim 19, wherein said receiver generates question postings, which are transmitted by means of said at least one data transmission network to said server providing said service and wherein said service of said server comprises answering said question postings.

23. The method as defined in claim 22, wherein said server refers to at least one other server and/or to sub-service providers to obtain necessary information for answering said question postings.

24. The method as defined in claim 22, further comprising providing additional information to said receiver from said service of said server that is not expressly required by said receiver, in order to increase service quality provided by said server.

25. The method as defined in claim 24, wherein said server providing said service obtains said additional information by retrieving said additional information from another service provided by another service provider.
